(19) United States
(12) Patent Application Publication
(10) Pub. No.: US 2009/0300157 A1
(43) Pub. Date: Dec. 3, 2009

(54) METHOD AND DEVICE FOR MANAGING AT LEAST ONE GROUP OF USERS, CORRESPONDING COMPUTER PROGRAM PRODUCT

(75) Inventors: Arnaud Longeanie, Saint Germain Sur IIIe (FR); Nathalie Chevalier, Chateaubourg (FR); Yves Scotto, Thorigne Fouillard (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: France Telecom, Paris (FR)

(21) Appl. No.: 12/279,455

(22) PCT Filed: Feb. 14, 2007
(86) PCT No.: PCT/EP2007/051438

§ 371 Date: Jan. 20, 2009

(30) Foreign Application Priority Data
Feb. 15, 2006 (FR) 0601333

(51) Int. Cl. G06F 15/173

(52) U.S. Cl. 709/223

(57) ABSTRACT

A method is provided for managing at least one group of users who have equipment able to intercommunicate via at least one communication network. This method includes a phase of inserting a new user into the groups, the phase itself including the following steps performed by an intermediate device: receiving, from a member of the group, a first request to insert the new user into the group; and inserting the new user into the group, after receiving the first and second insertion requests.

### CROSS-REFERENCE TO RELATED APPLICATIONS

This application is a Section 371 National Stage Application of International Application No. PCT/EP2007/051438, filed Feb. 14, 2007 and published as WO2007/093616 on Aug. 23, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure pertains to a technique for the management of groups of users among a plurality of users having apparatuses that can communicate with one another through at least one communications network.

The devices available to the users may, for example but not exclusively, be set top boxes (STBs), personal digital assistants (PDAs) and personal computers (PCs). These devices are for example of a programmable type but are not necessarily so.

The disclosure can be applied in any situation in which the users who are members of a group wish to exchange information, for example vocal, textual, video, data, applications or other types of information through at least one communications network.

### BACKGROUND OF THE DISCLOSURE

In the prior art, a CCITT X.25 standard defines a concept of a closed group of subscribers in a communications network with a session set-up facility as a set of correspondents authorised to set up sessions with one another. An extension of this concept to any communications system can be used to build groups of correspondents who may exchange messages solely between themselves. An authentication server is assigned a role proper to a switch compliant with the X.25 standard and may or may not authorize exchanges depending on the definition of the group (for example with a list of authorised correspondents or a network address mask). A correspondent cannot initiate an exchange with a member of the group unless he himself belongs to the group.

For example, there are groups of users who engage in discussion in an IM (instant messaging, i.e. Internet relay chat—RFC 1459) conference. The participants in a conference can see the texts sent by the participants in this conference but not the texts sent by participants in other conferences taking place at the same time.

At present, the insertion of a new user in one of these groups depends on one of the following two models:
insertion with validation based on the verification of characteristics provided by the new user who requests registration (for example verification based on an identity element provided by the applicant or else the sending of a confirmation email message to the address given by the applicant),
routine insertion without verification or validation (for example the applicant sends a request for registration to a public electronic message distribution list).

Once inserted in the group, the user can initiate communications with a subset of other members and the other members can initiate communications with him.

It is important to note that, in these two models, it is from the new user that the registration originates: it is him who asks to belong to a group of users. For this reason, the above-mentioned current technique for the management of a group of users has the disadvantage of enabling an ill-intentioned user to join a group by giving false information on his identity or aims. Often, this lack of control and authentication leads to disruptive use of the possibilities of exchange, as in the case of spam or unsolicited email to take only one example.

Furthermore, once inserted into the group, the member can no longer choose to participate exchange by exchange. His agreement covers all the exchanges.

A communications exchange set up between several members of a group enables the transmission of information (for example, text, images, sound, video sequences etc). Each participant in the exchange receives the same information and every participant receives what he sends.

Sometimes, the exchanges between correspondents rely on devices external to the system of exchange that are connected to or integrated with the above-mentioned communications devices. In this case, one of the participants can drive his external device and the view he has of it is transmitted to the other participants. The term “devices external to the system of exchange” is understood for example to mean other applications (other than communications) on a multi-task IT apparatus.

For example, applications-sharing software programs are used to share the use of an application among the participants. One of the participants launches the application at his station and the display of the application is reproduced in the exchange system of the other participants.

During exchanges relying on devices external to the exchange system, it is only the apparatus supporting the exchange (for example: the user's PC) that can be used to share his display with the other participants in the exchange.

### SUMMARY

One or more embodiments of the present invention provide a solution that does not have these drawbacks by proposing inter alia a technique for the management of groups of users which is simple and can be relied upon by each user.

One particular embodiment of the invention proposes a method for the management of at least one group of users having apparatuses that can communicate with one another through at least one communications network. This method comprises a phase of insertion of a new user into said group, this phase itself comprising the following steps performed by an intermediate device:
the reception from a member of said group of a first request for insertion of the new user into said group;
the reception from the new user of a second request for insertion of the new user into said group; and
the insertion of the new user into said group, after reception of said first and second insertion requests.

The intermediate device (such as a server for example) therefore plays a key role in such an embodiment since it is this intermediate device which verifies the following two conditions before inserting the new user into a group of a user who is already a member of this group: the user who is already a member should have formulated a request for insertion of the new user and the new user too should have formulated the same request. Thus, an ill-intentioned user cannot, on his own, get inserted into a group since no user who is already a member has made a request for such insertion to the intermediate device.

In practice, the new user receives for example a proposal of insertion in any form whatsoever. The term “proposal of insertion” is understood to mean any piece of information by which he learns of the existence of a group to which he can claim access. He receives this proposal for example through the network (coming for example from the intermediate device) or off the network (for example, verbally or in written form or in the form of electronic mail etc). In response, the new user sends his insertion request which for example can be qualified as being non-spontaneous or spontaneous depending on whether or not it is a response to a proposal for insertion received through the network.

The general principle of an embodiment of the invention therefore consists in making a proposal to a new member that he should join a group, and then in the acceptance by the new user of this proposal. Only the members of the group who have agreed to be members can participate in subsequent exchanges with the manager of the group and also with other members of this group. Each group is a territory of trust for the members who belong to it because these members are chosen by the manager (who sends them a proposal of insertion) and have agreed to belong to the group.

It must be noted that the above-mentioned mechanism of insertion of a new user according to an embodiment of the invention can be used (in being used as many times as needed) for the initial creation of a group of users and/or for the modification of an already existing group of users.

It must also be noted that each user, if he so wishes, can be the manager of one or more groups. However, a user may decide not to be a manager or may be satisfied with simply belonging to one or more groups managed by other users.

In one particular mode of implementation of an embodiment of the invention, said first and second insertion requests are spontaneous requests sent out independently of one another.

In this case, the order of reception of the first and second insertion requests is immaterial. The advantage is that the new user does not receive any proposal of insertion which, if it is of no interest to him, may be considered to be an undesired message (spam).

In one advantageous variant, the first insertion request is a spontaneous request. After the reception of the first insertion request, the intermediate device sends the new user a proposal of insertion. Said second insertion request is a non-spontaneous request sent in order to respond positively to said proposal of insertion.

Thus, in this variant, it is not from the new user that the registration in a group originates but from another user who already belongs to this group (only this user who is already a member spontaneously sends out an insertion request). The new user's task for being inserted into the group is facilitated since all he needs to do is respond to the proposal for insertion (he does not have to spontaneously send out an insertion request).

Advantageously, the insertion of the new user into said group, after reception of said first and second insertion requests, prompts an automatic insertion of said member, from whom said first insertion request must come, in at least one group of users managed by the new user.

Thus, without any manipulation on his part (without any sending of any proposal of insertion or more generally any insertion request from the user who is already a member of the new user's group or groups), the new user sees the group or groups of users of which he himself is the manager modified by the insertion of a new member.

An automatic insertion of this kind is actually executed: either automatically by the intermediate device (after reception of the first and second insertion requests) or following third and fourth insertion requests (by said member in a group of said new user) sent automatically by an apparatus of the user who is already a member and an apparatus of the new user (after the sending of the first and second insertion requests), transparently or not transparently for these users. In other words, this automatic insertion mechanism can be analyzed as follows:
the first insertion request includes or is indistinguishable from a third request for the insertion, in a group of users managed by the new user, of said member from whom said first insertion request must come;
the second insertion request includes or is indistinguishable from a fourth request for the insertion, in a group of users managed by the new user, of said member from whom said first insertion request must come; and
the insertion of said member, from whom said first insertion request must come, in said group managed by the new user, is done after reception of said third and fourth insertion requests.

Advantageously, the method includes a phase of elimination of a user from said group, itself comprising the following steps:
reception of a request for elimination of a user from said group, coming from a user or from a manager of said group;
elimination of said user from said group.

Thus, a user can at any time rescind his agreement to belong to a group of users. On his part, the manager may at any time remove a user from the group that he is managing.

Advantageously, an elimination of said user from the group following an request for removal prompts an automatic elimination of a sender of said elimination request from at least one group of users managed by said user.

Thus, without any manipulation on his part, and especially without sending any request for elimination, the user sees the group or group of users of which he is himself the manager modified by the elimination of a member.

Preferably, the method comprises a phase of initialization of an exchange within said group, itself comprising the following steps:
the transmission to one or more users belonging to said group of an invitation to an exchange;
the reception of at least one response to said invitation, each response coming from a user who has received said invitation;
for each response to the invitation that is an agreement, the addition of the user who has sent said response to the participants to said exchange.

Thus, a user who is a member of a group of users is allowed to participate in only certain exchanges within this group. In this case, an agreement by a user in response to a proposal for insertion in a group constitutes an agreement to receive invitations to participate in an exchange. Thus, the manager of the group (the manager) is assured that his invitations will be well received by the members of his group. Furthermore, each member of a group is assured that he will not receive unwanted invitations (spam).

In one particular embodiment of the invention, the invitation to participate in an exchange comes from a manager who is one of the users and who manages the group of users to which the users receiving the invitation to an exchange belong.

According to one characteristic, with said invitation coming from a manager of said group, the addition of a user as a participant in an exchange prompts the automatic addition of said user in a list of participating users for each of whom the manager is authorised to drive at least one external device connected to or integrated in the equipment available to said participating user.

Thus, the driving the external devices, connected to or integrated in the communications devices at the users' disposal, is optimized.

Advantageously, the method comprises a phase of removing a user from an ongoing exchange in which said user is involved, this phase itself comprising the following steps:
the reception of a request to remove said user from the ongoing exchange, coming from said user or from a manager of the group in which the ongoing exchange has been set up;
removal of said user from the ongoing exchange.

Thus, a user can at any time rescind his agreement to be part of an exchange. In other words, he leaves a sub-group of users constituted for this exchange.

Advantageously, the method comprises a phase of ending an ongoing exchange, this phase itself comprising the following steps:
the reception of a request for ending an ongoing exchange coming from the manager;
the interruption of the ongoing exchange for all the users participating in the exchange.

Thus, for his part, the manager may at any time put an end to an exchange that he has initiated.

In a first particular embodiment of the invention, the management method is implemented in a server capable of communicating through said at least one communications network with the apparatuses at the user's disposal.

This first embodiment therefore corresponds to a centralized implementation.

In a second particular embodiment of the invention, the management method is implemented in the apparatus at each manager's disposal.

This second embodiment therefore corresponds to a distributed implementation.

In another embodiment, the invention pertains to a computer program product downloadable from a communications network and/or recorded in a computer-readable carrier and/or executable by a processor, this computer program product comprising program code instructions for the execution of the steps of the above-mentioned method of management, when said program is executed in a computer.

In another embodiment, the invention concerns a device for the management of at least one group of users having apparatuses available that can communicate with one another through at least one communications network. This device comprises means of insertion of a new user into said group, themselves:
first means of reception enabling the reception, from a member of said group, of a first request for insertion of the new user into said group;
second means of reception enabling the reception, from the new user, of a second request for insertion of the new user into said group; and
means to insert of the new user into said group, after reception of said first and second insertion requests by said first and second reception means.

More generally, the management device of an embodiment of the invention includes means for implementing the method of management of at least one group of users, as described here above (in any of its different embodiments).

In another embodiment, the invention relates to a server capable of communicating, through a communications network, with apparatuses designed to be placed at the disposal of a plurality of users, this server comprising a management device as mentioned here above.

In another embodiment, the invention pertains to an apparatus comprising a management device as described here above.

### BRIEF DESCRIPTION OF THE DRAWINGS

Other features and advantages of embodiments of the invention shall appear more clearly from the following description of particular embodiments of the invention, given by way of indicative and non-exhaustive examples, and from the appended drawings of which:

FIG. 1 is a block diagram of an example of a system used to implement a particular embodiment of the method according to an embodiment of the invention for the management of at least one group of users;

FIGS. 2A and 2B respectively show an illustration and a flow chart of a same phase of insertion of a new user included in a particular embodiment of the method according to the invention;

FIGS. 3A and 3B respectively present an illustration and a flow chart of a same phase of initialization of an exchange, included in a particular embodiment of the method according to the invention;

FIGS. 4A and 4B respectively present an illustration and a flow chart of a same phase of removal of a user of an ongoing exchange, included in a particular embodiment of the method of the invention;

FIGS. 5A and 5B respectively show an illustration and a flow chart of a same phase of an end of an ongoing exchange, included in a particular embodiment of the method according to the invention;

FIGS. 6A and 6B respectively present an illustration and a flow chart of a same phase of elimination of a user from a group, included in a particular embodiment of the method of the invention;

FIG. 7 shows the structure of a device for the management of at least one group of users, in a particular embodiment of the invention; and

FIG. 8 is an illustration of a phase of insertion of a new user included in a second particular embodiment of the method according to the invention.

### DETAILED DESCRIPTION OF ILLUSTRATIVE EMBODIMENTS

In all the figures of the present document, the identical elements and steps are designated by a same numerical reference.

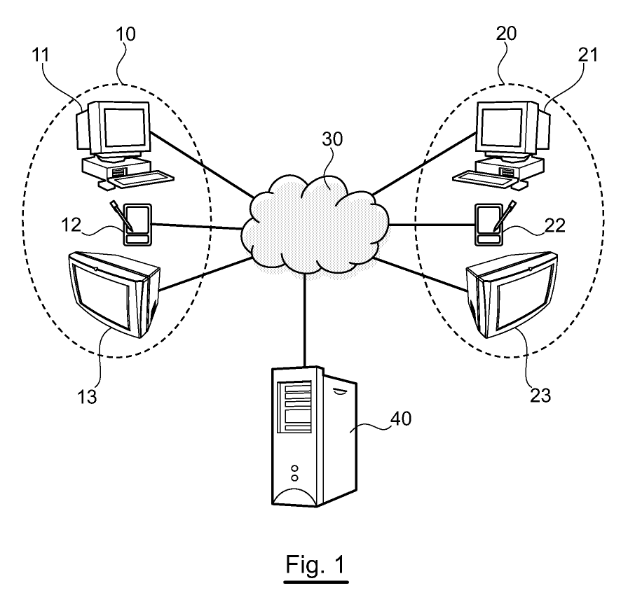

Referring now to FIG. 1, we present an example of a system for the implementation of a particular embodiment of the method according to the invention. In this example, the system comprises:
a first set 10 of terminal apparatuses of different types, for example a personal computer (or PC) 11, a personal digital assistant (or PDA) 12, and a set top box (or STB) 13;
a second set 20 of terminal apparatuses of different types, for example a personal computer (or PC) 21, a personal digital assistant (or PDA) 22 and a set top box (or STB) 23;
a communications network 30 enabling the terminal apparatuses 11, 12, 13, 21, 22, 23 of the two sets 10, 20 to communicate with one another and with the server 40;
a server 40 fulfilling the coordination and storage role.

It is assumed that the terminal apparatuses 11, 12, 13, 21, 22, 23 are placed at the disposal of a plurality of users so that they will exchange information (for example vocal, textual, video, data, application and other types of information) through the communications network 30.

It is also assumed that each set of users is managed by a manager belonging to the plurality of users.

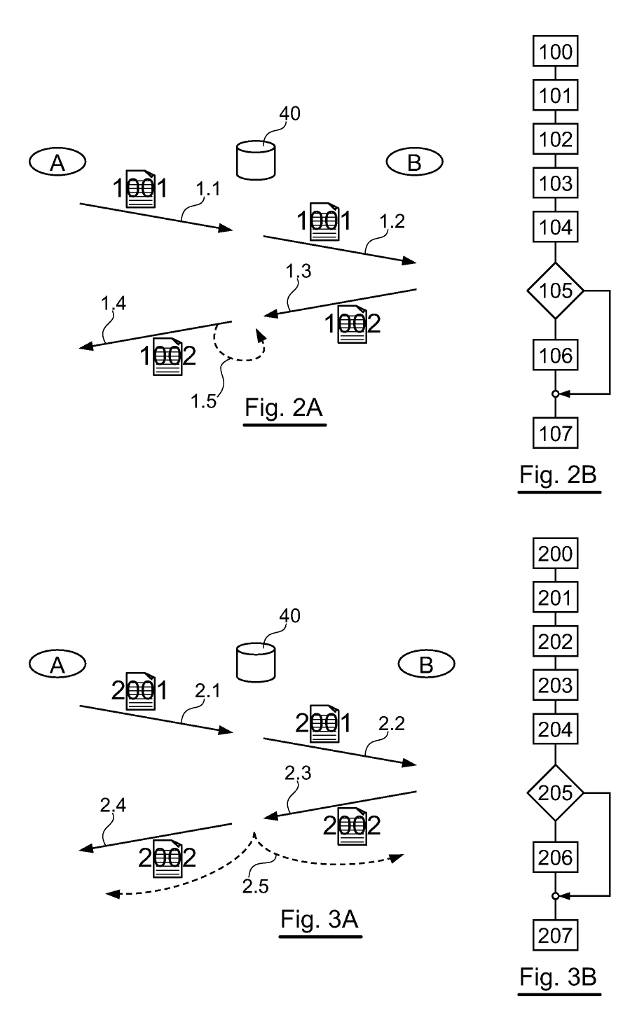

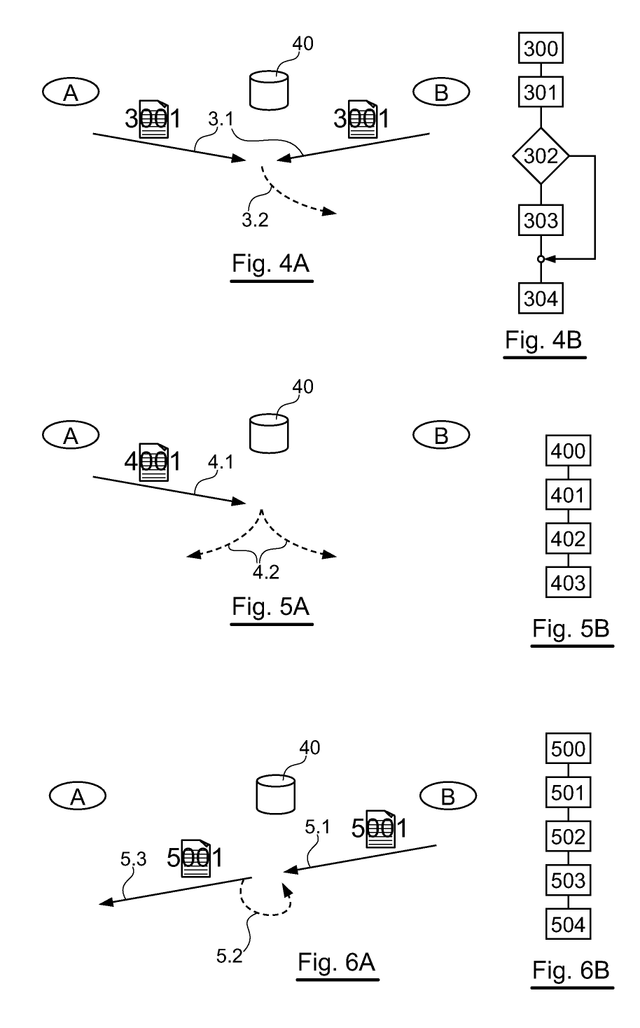

The server 40 executes different algorithms corresponding to different phases of a particular embodiment of the method according to the invention for the management of at least one group of users: a phase of insertion of a new user (see FIGS. 2A and 2B), a phase of initializing an exchange (see FIGS. 3A and 3B), a phase of removing a user from an ongoing exchange (see FIGS. 4A and 4B), a phase for ending an ongoing exchange (see FIGS. 5A and 5B) and a phase for eliminating a user from a group (see FIGS. 6A and 6B).

Referring now to FIG. 2B, we present the algorithm executed by the server 40 during the phase of insertion of a new user B into a group of users managed by a user A (manager of this group of users).

After a starting step 100, the server 40, in a step 101, receives a proposal 1001 for insertion into a group coming from the user A, from an apparatus of this user (for example one of the apparatuses 11, 12, 13 of the set referenced 10 in FIG. 1).

In a step 102, the server 40 sends the proposal of insertion 1001 to an apparatus (for example one of the apparatuses 21, 22, 23 of the set referenced 20 in FIG. 1) from the user B through the communications network 30.

In a step 103, the server 40 receives a response 1002 from the apparatus of the user B.

In a step 104, the server 40 sends the response 1002 from the user B to the apparatus of the user A, through the communications network 30.

In a step 105, the server 40 checks to see whether the response 1002 of the user B is an agreement. If the answer is yes, the server, in a step 106, inserts the user B into the group of the user A. If the answer is no, the operation passes directly to the end of the step 107.

Optionally, during the step 106, the server automatically inserts the user A into a group of the user B (i.e. a group of users for whom the user B is the manager).

FIG. 2A is an illustration of this phase of insertion of a new user. The arrows referenced 1.1, 1.2, 1.3, 1.4 and 1.5 in FIG. 2A correspond respectively to the steps 101, 102, 103, 104 and 106 in FIG. 2B.

Referring now to FIG. 3B, a description is provided of the algorithm executed by the server 40 during the phase of initialization of an exchange within a group of users, at the initiative of a user A (managing this group of users).

After a starting step 200, the server 40, in a step 201, receives an invitation 2001 to an exchange coming from the user A from an apparatus of this user.

In a step 202, the server 40 sends the invitation 2001 to an apparatus of a user B through the communications network 30.

In a step 203, the server 40 receives a response 2002 from the apparatus of the user B.

In a step 204, the server 40 sends a response 2002 from the user B to the apparatus of the user A, through the communications network 30.

In a step 205, the server 40 checks to see whether the response 2002 of the user B is an agreement. If the answer is yes, the server in a step 206 adds the user B to the participants in the exchange (i.e. the server connects the user A's communications stream to the user B's apparatus through the communications network 30). If the answer is no, the operation passes directly to the ending step 207.

Optionally, at the step 206, the server 40 automatically adds the user B to a list of users participating in the exchange for each of whom the user A (the manager) is authorised to drive at least one external device connected to or integrated into the device available to the participating user.

The external devices are for example driven by messages complying with the UPNP protocols (http://www.upnp.org/) for apparatuses of the manager (user A) and Jabber (RFC 3920 to 3923 and http://wwwjabber.org/) for the apparatuses of the other user (for example the user B) participating in the exchange.

FIG. 3A is an illustration of this phase of initialization of an exchange. The arrows referenced 2.1, 2.2, 2.3, 2.4 and 2.5 in FIG. 3A respectively correspond to the steps 201, 202, 203, 204 and 206 in FIG. 3B.

Referring now to FIG. 4B, we present the algorithm executed by the server 40 during the phase for removing a user B from an ongoing exchange within a group of users at the initiative of the user B or of a user A (manager of this group of users).

After a starting step 300, the server 40, in a step 301, receives a request 3001 for removing the user B from the exchange.

At a step 302, the server checks to see if the request for removal 3001 comes from the user A (the manager of the group) or the user B. If the answer is yes, the server 40, in a step 303 puts an end to the connection of the communication stream from the user A to the apparatus of the user B, through the communications network 30. If the answer is no, the operation passes directly to the end step 304.

FIG. 4A illustrates this phase for removing a user from an ongoing exchange. The arrows referenced 3.1 and 3.2 in FIG. 4A correspond respectively to the steps 301 and 303 in FIG. 4B.

Referring now to FIG. 5B, a description is provided of the algorithm executed by the server 40 during the phase of ending an ongoing exchange within a group of users, at the initiative of a user A (manager of this group of users).

After a starting step 400, the server 40, in a step 401, receives a request 4001 to put an end to the ongoing exchange.

In a step 402, the server 40 puts an end to the ongoing exchange by putting an end to the connection of the communications stream of the user A for all the users participating in the exchange. Then the server 40 goes to the end step 403.

FIG. 5A illustrates this end phase of an ongoing exchange. The arrows referenced 4.1 and 4.2 in FIG. 5A correspond respectively to the steps 401 and 402 in FIG. 5B.

Referring now to FIG. 6B, a description is provided of the algorithm executed by the server 40 during the phase for eliminating a user B from a group, at the initiative of this user B or of a user A (manager of this group of users).

After a starting step 500, the server 40, in a step 501, receives a request 5001 for the elimination of the user B from this group.

In a step 502, the server 40 eliminates the user B from the group and then, in a step 503, informs the user A of the elimination of the user B and then passes to the end step 504.

Optionally, in a step 502, the server will automatically eliminate the user A from a group of the user B (i.e. a group of users of which the user B is the manager).

FIG. 6A illustrates this phase of elimination of a user from a group. The arrows referenced 5.1, 5.2 and 5.3 in FIG. 6A correspond respectively to the steps 501, 502 and 503 in FIG. 6B.

The above-mentioned messages (also called signals) (1001, 1002, 2001, 2002, 3001, 4001 and 5001) exchanged during the implementation of the particular embodiment of the method according to the invention described here above could, for example, be compliant with the Web Services Description Language (WSDL) recommendation of the W3C (http://www.w3.org/TR/wsdl) or else compliant with rules proper to the C++ language. For each message, the definition in WSDL or C++ syntax will advantageously be followed by an example of an occurrence written in XML (eXtensible Mark Up Language).

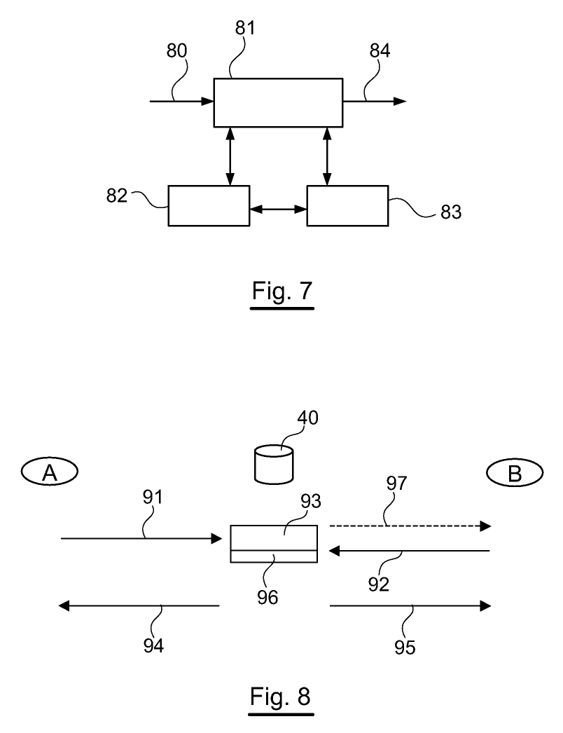

FIG. 7 presents a simplified structure of a device for the management of user groups according to a particular embodiment of the invention.

In the example described here above with reference to FIGS. 1, 2A, 2B, 3A, 3B, 4A, 4B, 5A, 5B, 6A and 6B, this user group management device is contained in the server 40.

In an alternative embodiment (not illustrated), this user group management device is included in the apparatus that is at the disposal of each manager.

The user group manager device comprises a memory 83, a processing unit 81 equipped for example with a microprocessor, and driven by a computer program 82 implementing the user group management method according to an embodiment of the invention. At initialization, the code instructions of the computer program 82 are loaded for example into a RAM and then executed by the processor of the processing unit 81. At input, the processing unit 81 receives different signals 80 (above-mentioned messages 1001, 1002, 2001, 2002, 3001, 4001 and 5001). The microprocessor of the processing unit 81 processes these signals 80 according to the instructions of the program 82 (i.e. according to the algorithms described here above with reference to FIGS. 2B, 3B, 4B, 5B et 6B). Apart from the group management operations performed internally to said device, the processing unit 81 outputs different messages 84 (above-mentioned messages 1001, 1002, 2001, 2002 and 5001).

Referring now to FIG. 8, we present an algorithm executed by the server 40 during a phase of insertion of a new user B in a group of users managed by a user A (the manager of this group of users) in a second particular embodiment of the method of the invention.

The server 40 receives the following through the communications network 30:
coming from the user A (from an apparatus of this user), a first request for insertion 91 of the new user B in a group managed by the user A; and
coming from the user B (from an apparatus of this user B) a second insertion request 92 for insertion of the new user B in a group managed by the user A.

If it has received the first and second insertion requests 91, 92, the server 40 inserts (93) the user B in the group of the user A and, optionally, it inserts (96) the user A in a group of the user B (i.e. a group of users of which the user B is the manager).

Through the communications network 30, the server 40 sends messages 94, 95 to the users A and B to inform them of the insertion of the user B in the group of the user A if this insertion has taken place.

In one particular mode of implementation, the first and second insertion requests 91,92 are spontaneous requests, sent independently of one another. The users A and B will, for example, first of all exchange their identifiers (telephone numbers for example) verbally or in writing and then each of them, if they so wish, will send an insertion request to the server. The order of reception by the server of the first and second insertion requests 91,92 is of no importance in this case.

In one variant of this particular embodiment, it is only the first insertion request 91, coming from the user A, that is spontaneous. By contrast, the second insertion request 92 is not spontaneous but is a positive response to an insertion proposal 97 (which the server has sent beforehand to the user B after having itself received the first registration request 91). It will be noted that this variant corresponds to the first embodiment of the insertion phase, presented here above with reference to FIGS. 2A and 2B.

Although the present disclosure has been described with reference to one or more examples, workers skilled in the art will recognize that changes may be made in form and detail without departing from the scope of the disclosure and/or the appended claims.

1. Method for management of at least one group of users having apparatuses that can communicate with one another through at least one communications network, wherein the method comprises a phase of insertion of a new user into said group, this phase itself comprising the following steps performed by an intermediate device:
reception from a member of said group of a first request for insertion of the new user into said group;
reception from the new user of a second request for insertion of the new user into said group; and
insertion of the new user into said group, after reception of said first and second insertion requests.

2. Method according to claim 1 wherein said first and second insertion requests are spontaneous requests sent out independently of one another.

3. Method according to claim 1, wherein the first insertion request is a spontaneous request,
and, after the reception of the first insertion request, the intermediate device sends the new user a proposal of insertion,
and said second insertion request is a non-spontaneous request sent in order to respond positively to said proposal of insertion.

4. Method according to claim 1, wherein the insertion of the new user into said group, after reception of said first and second insertion requests, prompts an automatic insertion of said member, from whom said first insertion request must come, in at least one group of users managed by the new user.

5. Method according to claim 1, wherein comprises a phase of elimination of a user from said group, comprising the following steps:
reception of a request (5001) for elimination of a user from said group, coming from a user or from a manager of said group;
elimination of said user from said group.

6. Method according to claim 5, wherein an elimination of said user from the group following a request for removal prompts an automatic elimination of a sender of said elimination request from at least one group of users managed by said user.

7. Method according to claim 1, wherein the method comprises a phase of initialization of an exchange within said group, comprising the following steps:
transmission to one or more users belonging to said group of an invitation to an exchange;
reception of at least one response to said invitation, each response coming from a user who has received said invitation;
for each response to the invitation that is an agreement, addition of the user who has sent said response to the participants to said exchange.

8. Method according to claim 7, wherein with said invitation coming from a manager of said group, addition of a user as a participant in an exchange prompts an automatic addition of said user in a list of participating users for each of whom the manager is authorised to drive at least one external device connected to or integrated in equipment available to said participating user.

9. Method according to claim 1, wherein the method comprises a phase of removing a user from an ongoing exchange in which said user is involved, this phase comprising the following steps:
reception of a request to remove said user from the ongoing exchange, coming from said user or from a manager of the group in which the ongoing exchange has been set up;
removal of said user from the ongoing exchange.

10. Method according to claim 1, wherein the method comprises a phase of ending an ongoing exchange, this phase comprising the following steps:
reception of a request for ending an ongoing exchange coming from the manager;
interruption of the ongoing exchange for all the users participating in the exchange.

11. Computer program product recorded in a computer-readable carrier, this computer program product comprising program code instructions for execution of a method of managing at least one group of users having apparatuses that can communicate with one another through at least one communications network, when said program is executed in a computer, wherein the method comprises a phase of insertion of a new user into said group, this phase itself comprising the following steps performed by an intermediate device:
reception from a member of said group of a first request for insertion of the new user into said group;
reception from the new user of a second request for insertion of the new user into said group; and
insertion of the new user into said group, after reception of said first and second insertion requests.

12. Device for management of at least one group of users having apparatuses available that can communicate with one another through at least one communications network, wherein the device comprises means of insertion of a new user into said group, wherein the means of insertion comprise:
first means of reception enabling reception, from a member of said group, of a first request for insertion of the new user into said group;
second means of reception enabling reception, from the new user, of a second request for insertion of the new user into said group; and
means to insert the new user into said group, after reception of said first and second insertion requests by said first and second reception means.
